(19) United States
(12) Patent Application Publication
(10) Pub. No.: US 2023/0173687 A1
(43) Pub. Date: Jun. 8, 2023

(54) CLAMPING LINEAR ACTUATOR

(71) Applicant: RAY GIVENS, London (CA)

(72) Inventors: RAY GIVENS, London (CA); CAMERON WADE ROADHOUSE, London (CA)

(21) Appl. No.: 18/073,838

(22) Filed: Dec. 2, 2022

Related U.S. Application Data
(60) Provisional application No. 63/285,559, filed on Dec. 3, 2021.

(51) Int. Cl. B25J 15/02; B25J 15/00; B25J 19/06; B25J 19/02

(52) U.S. Cl. CPC B25J 15/028; B25J 15/0028; B25J 19/06; B25J 19/02

(57) ABSTRACT

A linear actuator having a housing, a shaft having a proximate end attached to the housing and a distal end which moves relative to the housing, a first attachment point on one of the housing or the distal end of the shaft, a second attachment point connected to the other of the housing or the distal end of the shaft by way of one or more springs, and a motor that is operatively engaged with the shaft to drive movement of the shaft. The linear actuator may be connected within any desired mechanism with at least two parts that move relative to one another, such as a mechanical gripper, by connecting one part to the first attachment point and the other part to the second attachment point.

### FIELD OF THE INVENTION

The present invention relates to linear actuators and, in particular, to an electric clamping linear actuator and an electric gripper.

### BACKGROUND

Commercially-available electric linear actuators have been in use for a number of years. Electric linear actuators serve the same function as pneumatic cylinders: they provide a force that can be used in machines to move machine parts. Air cylinders are very inexpensive, but they are inefficient when compared to electric actuators and require a source of compressed air to operate.

An electric actuator typically uses a screw or spindle to drive a shaft out of a sleeve. The screw is turned by an electric motor, generally through a gear reduction. The key to any linear actuator is a set of limit switches at either end of travel that shut down the motor before the nut runs out of travel along the screw.

One of the most significant drawbacks with all electric linear actuators is that they are not designed to clamp (or grip) hard objects. Linear actuators are designed to come to a stop only when a limit switch is contacted. In general, they cannot collide with a hard object at an unpredictable location, without damaging the object, the linear actuator, or both. This problem arises most often with grippers, because there is no way to stop a turning motor quickly enough when gripping or clamping. It is possible to make an electric linear actuator clamp, but one of 2 methods have to be employed.

The actuator can proceed rapidly toward the object to be clamped and then slow down just before the collision. For this, it is necessary to know exactly the size of the object or many sizes if there are many objects. To slow down, it is necessary to have a sophisticated controller to know when to slow down and how to slow down. When the collision happens, the controller has to be able to monitor the current being drawn by the motor and shut the motor down very quickly when it detects a rise in the current.

Alternatively, the actuator can advance rapidly toward the object until it collides. In this case, the motor will have substantial momentum and will overload the screw, the nut, or the gear reduction, resulting in a shortened life for the actuator. Also, there has to be some way to shut off the motor after the collision, such as a limit switch to detect the object. In testing, a typical electric linear actuator will run this way for approximately 80,000 cycles before overheating or mechanical failure occurs.

In either case, as soon as the motor is shut off, the grip on the object will loosen. In the case of a gripper hung from a hoist, for example, the load could fall. This danger also arises if power is lost. Even if a spring-actuated brake is applied to the turning of the motor, if the load is jostled, it may fall. There is nothing to maintain the gripping force after the motor stops. This is in sharp contrast to an air cylinder, which maintains a strong grip even when the load is jostled and even after a loss of air (for a period of time).

Accordingly, there is a need for an improved electric clamping linear actuator to overcome these limitations with existing electric linear actuators and provide a more efficient alternative to pneumatic clamping linear actuators, without the need for a source of compressed air.

### SUMMARY OF THE INVENTION

A linear actuator, according to the present invention, has a housing, a shaft having a proximate end attached to the housing and a distal end which moves relative to the housing, a first attachment point on one of the housing or the distal end of the shaft, a second attachment point connected to the other of the housing or the distal end of the shaft by way of one or more springs, and a motor that is operatively engaged with the shaft to drive movement of the shaft. The linear actuator may be connected within any desired mechanism with at least two parts that move relative to one another, such as a mechanical gripper, by connecting one part to the first attachment point and the other part to the second attachment point.

In another embodiment, the shaft is attached to the housing by way of a nut and a spindle. The spindle is rotated by the motor to cause the shaft to move reciprocatingly relative to the housing.

In another embodiment, the second attachment point is on a plate connected to the housing by the one or more springs. Each of the one or more springs is attached at one end to the housing and at the other end to one end of a spring shaft. The other end of the spring shaft is attached to the plate, such that the plate is biased against the housing by the one or more springs.

In another embodiment, a single spring is positioned concentrically about the shaft and the second attachment point is on a plate connected to the distal end of the shaft by the single spring. The single spring extends along the shaft to bias the plate away from the distal end of the shaft towards the proximate end.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a rear perspective view of a linear actuator, according to the present invention.

FIG. 2 is a bottom perspective view of the linear actuator of FIG. 1.

FIG. 3 is a side view of the linear actuator of FIG. 1, connected to a gripping mechanism, in an extended position.

FIG. 4 is a side view of the assembly of FIG. 3 at the point that the mobile gripper collides with an object.

FIG. 5 is a side view of the assembly of FIG. 3, showing the compression of the springs as the linear actuator continues to retract after the mobile gripper collides with an object.

FIG. 6 is a side view of the linear actuator of FIG. 1.

FIG. 7 is a detail view of area A in FIG. 6, showing the limit switch and pin of the linear actuator of FIG. 1.

FIG. 8 is a top view of the linear actuator of FIG. 1.

FIG. 9 is a detail view of the area B in FIG. 8, showing the limit switch and pin of the linear actuator of FIG. 1.

FIG. 10 is a side sectional view of the linear actuator of FIG. 1, along the line C-C in FIG. 8.

FIG. 11 is a detail view of the area Din FIG. 10, showing the limit switch and nut of the linear actuator of FIG. 1.

FIG. 12 is a rear view of the linear actuator of FIG. 1, with the plate and rear of the housing removed to show the gear reduction inside the housing.

FIG. 13 is a perspective view of a single-spring embodiment of a linear actuator, according to the present invention, illustrated in a gripper application.

FIG. 14 is a side view of the linear actuator of FIG. 13.

FIG. 15 is a top view of the linear actuator of FIG. 13.

FIG. 16 is a perspective view of the linear actuator of FIG. 13, shown in a retracted position.

FIG. 17 is a side view of the linear actuator of FIG. 16.

FIG. 18 is a side-sectional view of the linear actuator of FIG. 13, along the lines E-E in FIG. 15.

FIG. 19 is a side-sectional view of the linear actuator of FIG. 13, along the lines E-E in FIG. 15, shown in a retracted position.

FIG. 20 is a side-sectional view of the linear actuator of FIG. 13, along the lines E-E in FIG. 15, showing the compression of the spring as the maximum retraction distance.

FIG. 21 is a perspective view of another gripper configuration of the linear actuator of FIG. 13.

### DESCRIPTION OF THE INVENTION

The linear actuator, according to the present invention, has a set of springs configured to compress when an object is clamped and to shut down the motor once the springs have been depressed. A brake is then applied to hold the position of the linear actuator. The linear actuator thereby clamps the object with a powerful grip and maintains the grip without further power consumption.

The linear actuator is, accordingly, able to operate substantially the same way as a pneumatic clamping linear actuator, but more efficiently and without the need for a source of compressed air. For example, the linear actuator could be used in robot grippers, where a strong grip is necessary. Typically, compressed air would be fed along the robot to a pneumatic end effector, even though the robot itself is entirely electric. This creates the need for additional lines and connections on the robot. Where compressed air is not available, is inconvenient, or is otherwise undesirable, the present linear actuator could be used. Also, mobile applications, such as autonomous guided vehicles (AGVs), battery operated tuggers, flatcars, etc. could also benefit from the present invention, as these mobile applications generally do not have access to compressed air, unless an on-board compressor is provided. Another potential application of the present invention is on grippers hanging from overhead gantry cranes, which are generally electric with no supply of compressed air for a pneumatic gripper.

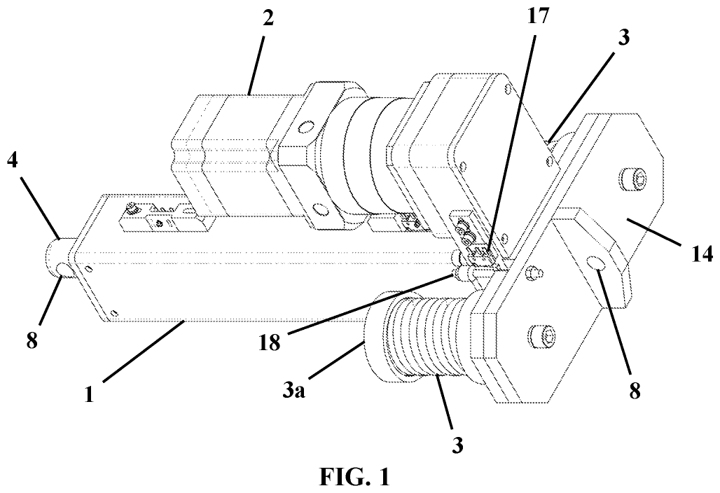

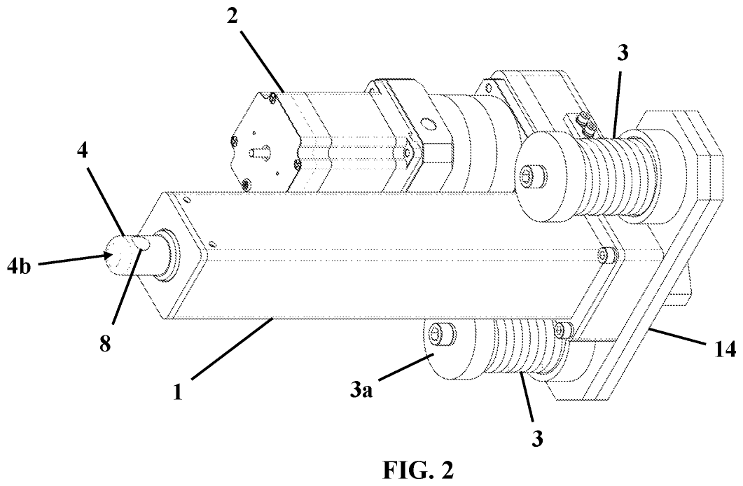

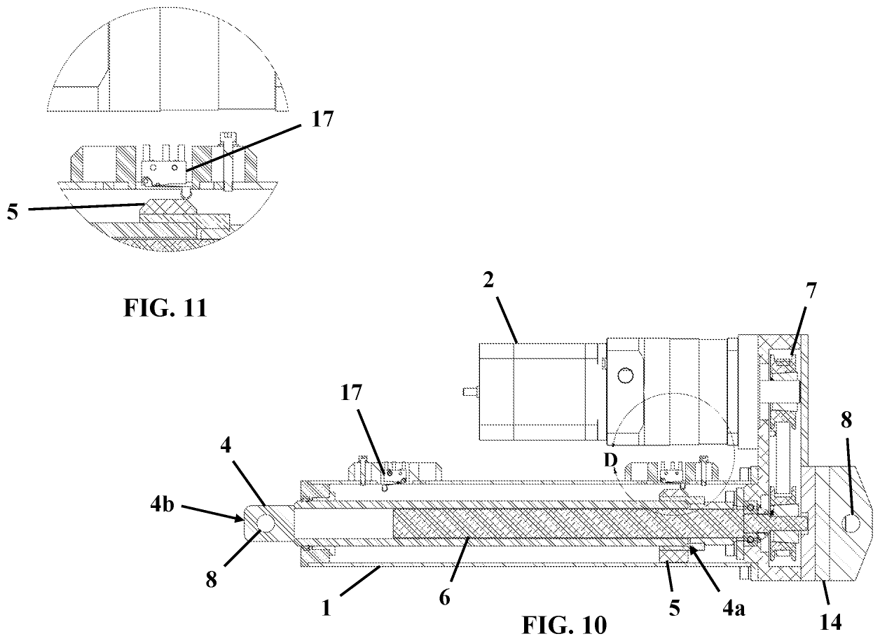

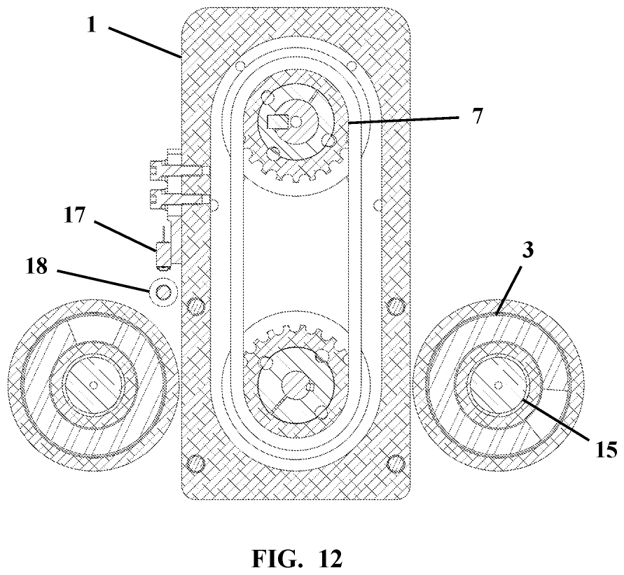

As shown in FIGS. 1 and 2, the linear actuator has a housing 1, a motor 2, one or more springs 3, and a controller (not shown). The housing 1 contains the mechanical parts of the linear actuator. A shaft 4 is attached to the housing 1, so as to move reciprocatingly relative to the housing 1. Preferably, the shaft 4 is mounted within the housing 1, by way of a nut 5 at a proximate end 4a of the shaft 4, on a spindle 6. The distal end 4b of the shaft 4 extends outside of the housing 1. As shown in FIGS. 10 and 12, the spindle 6 is connected to the motor 2 by way of a gear reduction 7 and is selectively rotated by the motor 2 to extend and retract the shaft 4 from the housing 1 to operate the linear actuator. Any similar mechanism may be used that converts the driving force from the motor 2 into linear reciprocating movement of the shaft 4 relative to the housing 1.

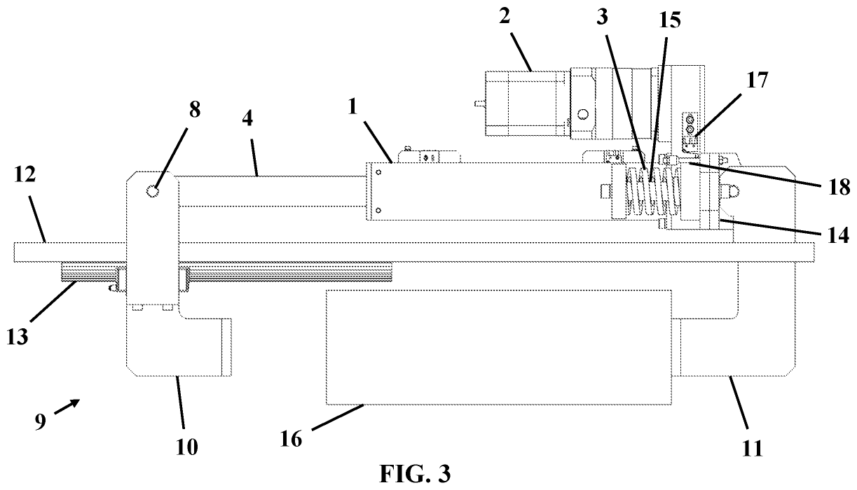

An attachment point 8 at the distal end 4b of the shaft 4 is configured to connect to a tool or a moving part of a machine, such as a gripping mechanism 9, for example, as shown in FIGS. 3-5. In the example shown in FIGS. 3-5, the gripping mechanism 9 has one mobile gripper 10 and one stationary gripper 11, mounted on a frame 12. The mobile gripper 10 is slidably mounted on the frame 12 by way of a rail 13 or other type of linear track extending along the travel distance of the mobile gripper 10, as defined by the linear actuator. The stationary gripper 11 is attached to a second attachment point 8 on a plate 14 on the rear of the housing 1, such that both grippers 10 and 11 are connected to opposite ends of the linear actuator.

As shown in FIGS. 1 and 2, the plate 14 is mounted on the housing 1 by way of the springs 3. Preferably, each spring 3 has a spring shaft 15 mounted concentrically within the spring 3 and attached to one end of the spring 3 by way of a flange or washer 3a. The other end of each spring 3 is attached to the housing 1 and the other end of each spring shaft 15 is attached to the plate 14. The plate 14 is biased against the housing 1 by the springs 3, so that the plate 14 abuts or rests against the housing 1 in the absence of a compressing force on the springs 3. The plate 14 may be any desired size, shape, or configuration as long as it provides an attachment point 8 and is movable relative to the housing 1.

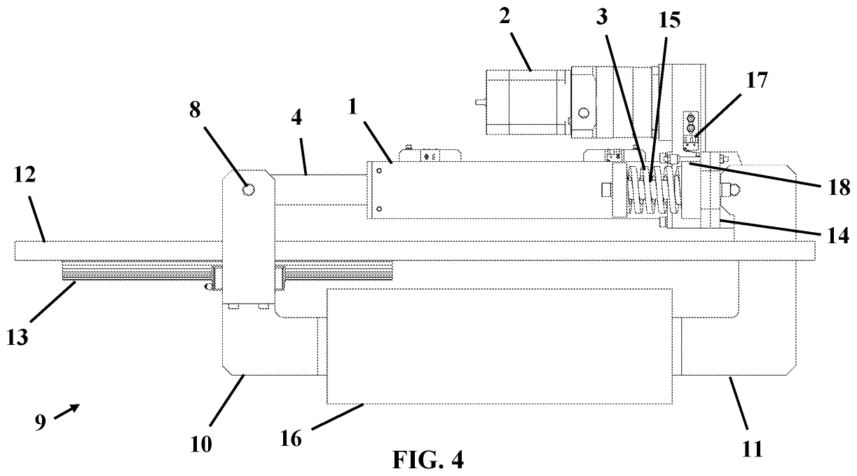

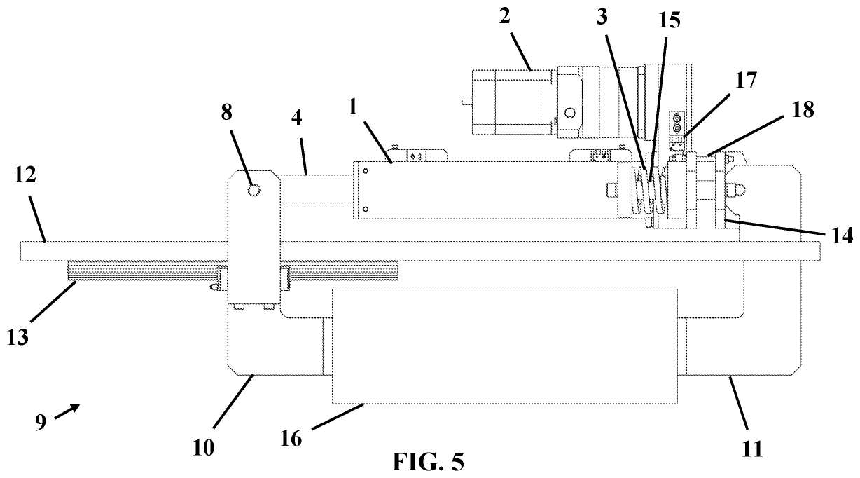

As shown in FIG. 3, when the linear actuator is in an extended position, the mobile gripper 10 is extended away from the stationary gripper 11. When the motor is engaged to retract the shaft 4 of the linear actuator, the mobile gripper 10 is moved towards the stationary gripper 11. When the mobile gripper 10 is moved towards the stationary gripper 11, it may come into contact with an object 16, as shown in FIG. 4. As the motor 2 continues to retract the shaft 4, the mobile gripper 10 can no longer move towards the stationary gripper 11, due to a collision with the object 16. Instead, the continued retraction of the shaft 4 compresses the springs 3, thereby moving the plate 14 away from the housing 1, as shown in FIG. 5.

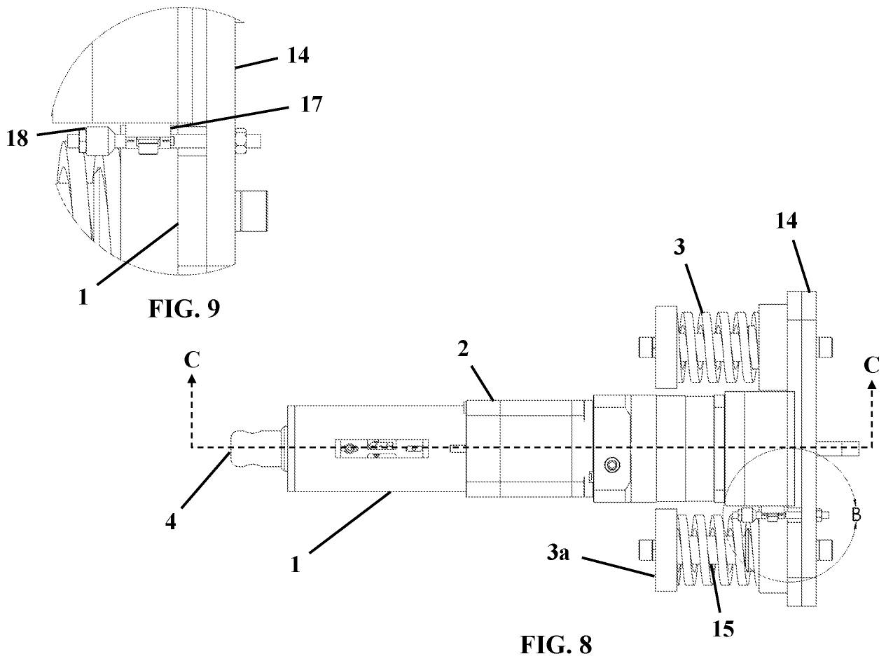

As shown in FIGS. 1-12, a limit switch 17 is configured to detect the compression of the springs 3 and shut off the motor 2. Once the motor 2 is shut off, a brake is applied to hold the linear actuator in the retracted position, maintaining the grip on the object 16 by the compression force of the springs 3. In this way, the impact of the collision between the mobile gripper 10 and the object 16 is absorbed by the springs 3, limiting the mechanical strain on the linear actuator. This permits the motor 2 to retract the shaft 4 of the linear actuator rapidly (even at full speed) without needing to slow down before the mobile gripper 10 collides with the object 16 and without damaging the mechanism of the linear actuator. This also permits the linear actuator to close the jaws of the gripping mechanism 9 on an object 16 of any size, because the limit switch 17 is triggered by the compression of the springs 3, regardless of where along its travel distance the shaft 4 has been retracted when the springs 3 are compressed.

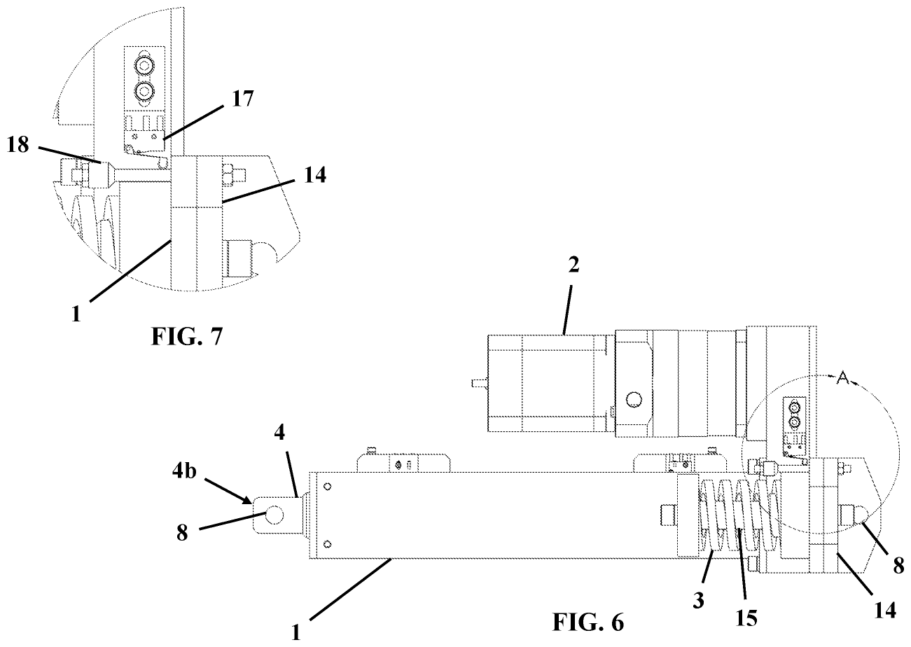

Any suitable type of limit switch 17 may be used and may be actuated in any number of ways, as long as the limit switch 17 is able to detect a specific compression distance of the springs 3. As shown in FIGS. 6-9, a lever-type limit switch 17 is positioned on the housing 1 adjacent to one of the springs 3, so as to be actuated when the spring 3 reaches a pre-selected amount of compression, by a pin 18 attached to the plate 14. As the shaft 4 of the linear actuator is retracted by the motor 2 and the mobile gripper 10 collides with an object 16, the continued retraction of the shaft 4 causes the housing 1 to be pulled away from the plate 14. The spring shaft 15, which is attached to the plate 14 remains in place, while the housing 1 moves, causing compression of the springs 3. As the springs 3 are compressed, the pin 18, which is attached to the plate 14, moves relative to the housing 1. The end of the pin 18 has a larger diameter than the shaft of the pin 18 or is otherwise shaped so that the end of the pin 18 acts as a cam to engage the limit switch 17 as the pin 18 reaches a pre-selected position, corresponding to the desired compression distance of the springs 3.

Optionally, the linear actuator may be provided with a plurality of limit switches 17 positioned at different selected locations along the compression distance of the springs 3. Each of these limit switches 17 sends a signal to the controller at its selected compression distance of the springs 3. For any given type and size of spring 3, the compression force will be known at various compression distances. The controller can select which limit switch signal to use to shut off the motor 2 and apply the brake, thereby selecting the gripping strength of the gripping mechanism 9. This enables the linear actuator to selectively use a low gripping strength to grip light or delicate objects 16 or a high gripping strength to grip heavier objects 16 without the need for downtime to reconfigure or manually adjust the mechanism. For example, a linear actuator may have three limit switches 17, arranged at ¼, ½, and ¾ of the full compression distance of the springs 3. Other arrangements are also possible, depending on the desired amount of gripping strength or the desired number of gripping strength options for the particular application.

As shown in FIGS. 10 and 11, the linear actuator may also have limit switches 17 on the housing 1, positioned at the ends of the travel distance of the shaft 4. These limit switches 17 act as extend and retract limit switches to stop the motion of the motor 2 and the shaft 4 when the shaft 4 is approaching the ends of its extension and retraction travel distance to prevent damaging the mechanical components of the linear actuator. These limit switches 17 may be any type of limit switch, but are preferably also lever-type limit switches 17 that are actuated by the nut 5 on the end of the shaft 4 that moves inside the housing 1. The nut 5 may be shaped to act as a cam that engages the limit switches 17 as the shaft 4 is extended or retracted.

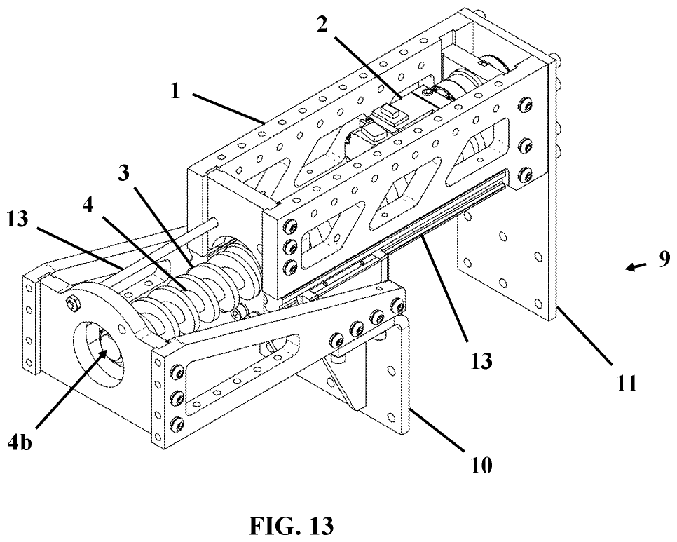

Alternatively, as shown in FIGS. 13-21, the linear actuator may be configured to stop the motion of the motor 2, without limit switches 17. Instead, the motor 2 may be a servo motor and the controller operating the linear actuator may monitor the power consumption of the motor 2 as it operates. As the shaft 4 of the linear actuator is retracted (or extended) by the motor 2 and the mobile gripper 10 collides with an object 16, the power consumption of the motor 2 increases, in response to the increased resistance of the spring 3. As a result, the power consumption of the motor 2 required to move the shaft 4 will be higher when the motor 2 is also required to compress the one or more springs 3, relative to moving the shaft 4 without compressing the one or more springs 3. This increased power consumption can be used as a signal from the motor 2 in a similar way to the signal produced by a limit switch 17 to trigger the shut down of the motor 2 and application of the brake to grip the object 16, as described above.

This configuration of the linear actuator, without limit switches 17, can also be configured to selectively apply different gripping strength. In this configuration, rather than doing so by selecting which of a plurality of limit switches 17 to monitor for a given compression distance on the one or more springs 3, the controller can monitor the power consumption of the motor 2 until it reaches a level that corresponds to a desired compression distance on the one or more springs 3. This is because a known set of one or more springs 3 will produce a known amount of resistance, and therefore a known increase in power consumption of the motor 2, as the springs 3 are compressed by varying compression distances. As a result, the power consumption of the motor 2 varies in a predictable manner, depending on the compression distance of the one or more springs 3. The controller can be programmed to shut down the motor 2, once its power consumption reaches a level that corresponds to the compression distance required to produce the desired gripping strength on an object 16.

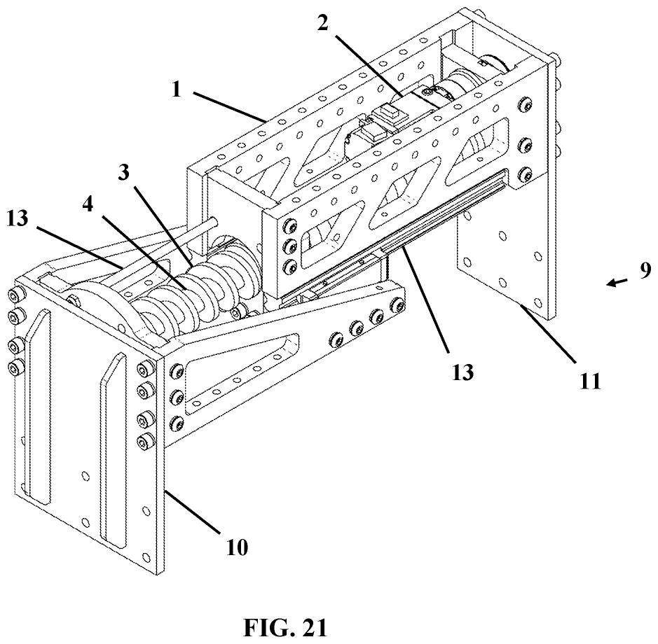

In the embodiment illustrated in FIGS. 1-12, the attachment point 8 on the distal end 4b of the shaft 4 is directly on or rigidly attached to the distal end 4b of the shaft 4 and the attachment point 8 on the housing 1 is connected to the housing 1 by way of one or more springs 3. Preferably, as shown in FIGS. 1-12, the attachment point 8 is on a plate 14, which is connected to the housing 1 by two springs 3. Two springs 3 are preferable to a single spring 3 in more heavy duty applications, due to the cost of a single higher gauge spring 3, which would be required to accommodate the compression forces required during use, as compared to two relatively lower gauge springs 3. However, in some applications a single-spring 3 embodiment, such as the one illustrated in FIGS. 13-21, may be preferable. As shown in FIGS. 13-20, the two grippers of the gripping mechanism 9 are positioned closely together for gripping smaller objects. Alternatively, FIG. 21 illustrates another position of the mobile gripper 10, with the grippers spaced farther apart for gripping larger objects.

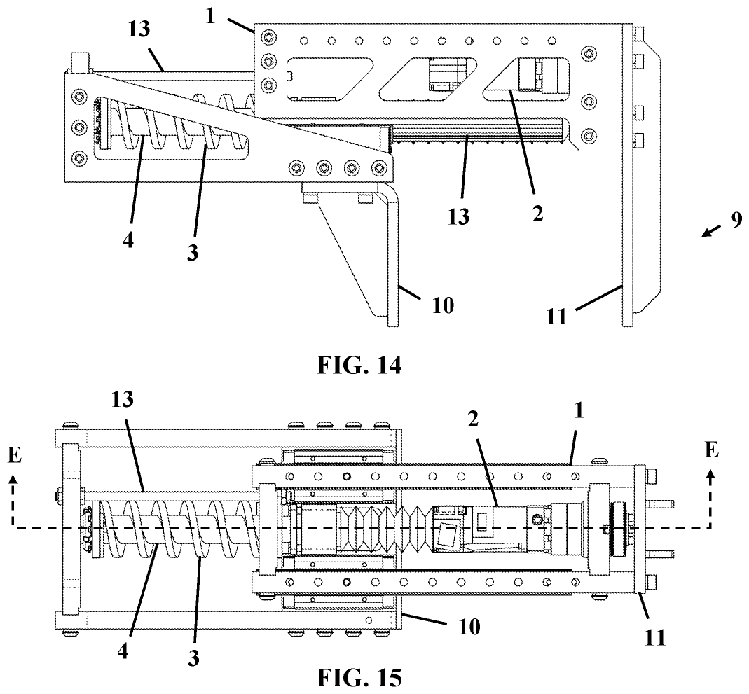

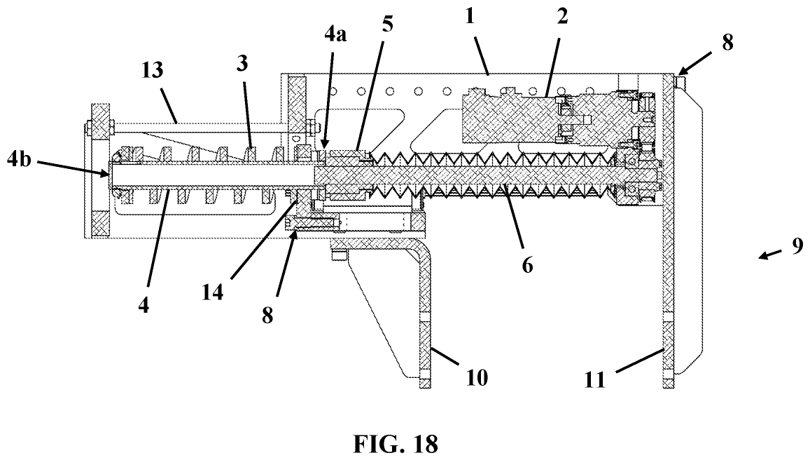

As shown in FIG. 13, the stationary gripper 11 is attached directly to the housing 1, while the mobile gripper 10 is connected to the distal end 4b of the shaft 4 by way of a spring 3. The mobile gripper 10 travels along rails 13 attached to the housing 1, preferably on either side of the housing 1. There may also be an additional rail 13 parallel to but out of plane with the other rails 13 to provide additional stability around the single spring 3. As shown in FIGS. 14 and 15, the spring 3 is attached at one end to the distal end 4b of the shaft 4 and is positioned concentrically about the shaft 4. As shown in FIGS. 18-20, the spring 3 extends along the shaft 4 and the other end of the spring 3 is attached to a plate 14, which provides the attachment point 8 for the mobile gripper 10. Preferably, the plate 14 in this embodiment is biased away from the distal end 4b of the shaft 4 and towards the proximate end 4a.

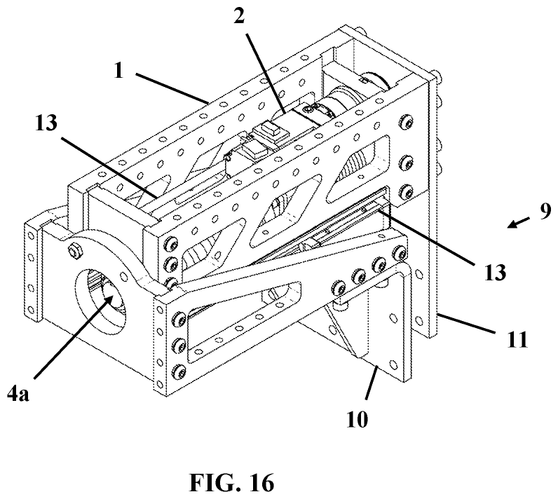

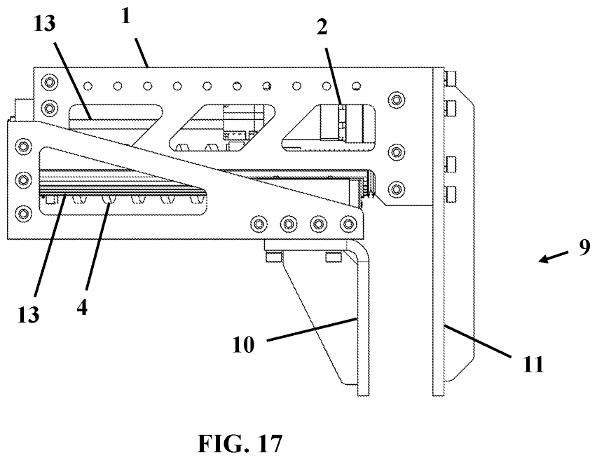

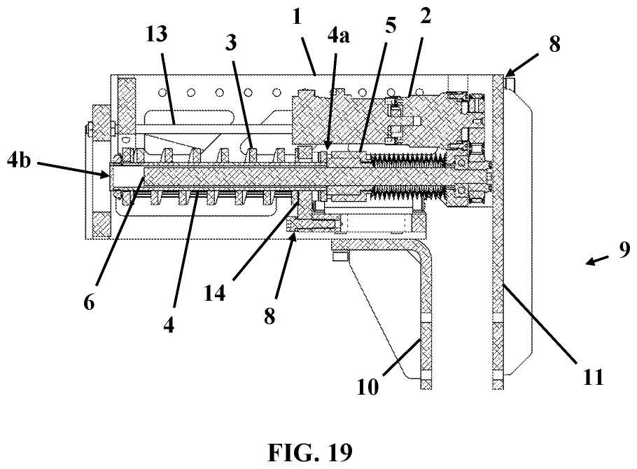

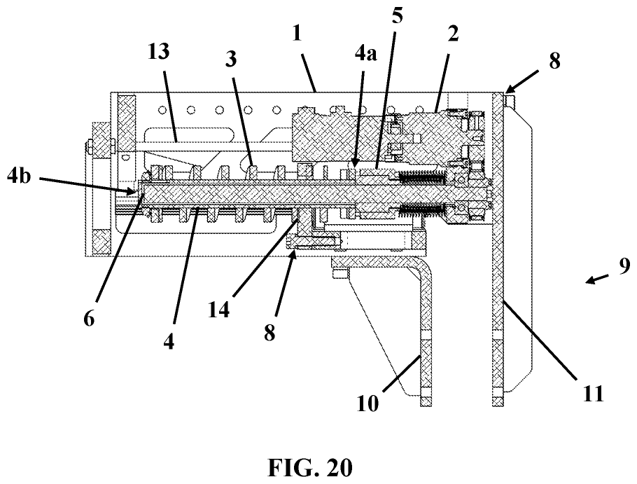

FIGS. 13-15 illustrate the single-spring linear actuator in an extended position, while FIGS. 16 and 17 illustrate the retracted position. As shown in FIGS. 18-20, the linear actuator moves from the extended position (FIG. 18), until the gripping mechanism 9 contacts an object 16 or the mobile gripper 10 reaches its maximum travel distance (FIG. 19). At this point, the motor 2 continues to operate and the spindle 6 continues to turn, thereby further retracting the shaft 4. However, the plate 14 remains stationary and the spring 3 compresses (FIG. 20). The motor 2 may be a servo motor and the resulting increase in power consumption may be used as a signal to stop the movement of the motor 2 and apply a brake. Alternatively, one or more limit switches 17 may be used, as described above and illustrated in FIGS. 1-12.

Although the exemplary embodiment of a gripping mechanism 9 has been used to describe and illustrate the linear actuator in the present application, the linear actuator may be configured for use in any application where a linear actuator is suitable. The linear actuator may be connected within any desired mechanism with two parts that move relative to one another by connecting one of the two parts to the shaft 4 and the other part to the housing 1, with one of them connected via the plate 14 and spring 3. Similarly, although the linear actuator has been described and illustrated in a configuration where the compression of the springs 3 occurs when the shaft 4 is retracted, the linear actuator may also be configured so that the compression of the springs 3 occurs when the shaft 4 is extended. This may be done, for example, by spacing the plate 14 apart from the housing 1 and positioning the springs 3 between the plate 14 and the housing 1.

The present invention has been described and illustrated with reference to an exemplary embodiment, however, it will be understood by those skilled in the art that various changes may be made and equivalents may be substituted for elements thereof without departing from the scope of the invention as set out in the following claims. Therefore, it is intended that the invention not be limited to the particular embodiments disclosed herein.

What is claimed is:

1. A linear actuator, comprising:
a housing;
a shaft having a proximate end attached to the housing and a distal end which moves relative to the housing;
a first attachment point on one of the housing or the distal end of the shaft;
a second attachment point connected to the other of the housing or the distal end of the shaft by way of one or more springs; and
a motor operatively engaged with the shaft to drive the movement of the shaft.

2. The linear actuator of claim 1, wherein the distal end of the shaft moves reciprocatingly relative to the housing.

3. The linear actuator of claim 2, wherein the shaft is attached to the housing by way of a nut and a spindle, and wherein the spindle is rotated by the motor to cause the reciprocating movement of the shaft.

4. The linear actuator of claim 2, wherein the linear actuator is operatively engaged with a gripper mechanism having a mobile gripper and a stationary gripper, and wherein each of the first and second attachment points are attached to one of the mobile gripper and the stationary gripper.

5. The linear actuator of claim 4, wherein a rail is attached to the housing and the mobile gripper is slidably mounted on the rail.

6. The linear actuator of claim 2, wherein the second attachment point is on a plate connected to the housing by the one or more springs.

7. The linear actuator of claim 6, wherein each of the one or more springs is attached at one end to the housing and at the other end to one end of a spring shaft, and wherein the other end of the spring shaft is attached to the plate, such that the plate is biased against the housing by the one or more springs.

8. The linear actuator of claim 6, wherein the second attachment point is on a plate connected to the distal end of the shaft by the one or more springs.

9. The linear actuator of claim 8, wherein the one or more springs are one spring, which is positioned concentrically about the shaft and extends along the shaft to bias the plate away from the distal end of the shaft towards the proximate end.

10. The linear actuator of claim 2, having a limit switch configured to detect the compression of the one or more springs and trigger the shut off of the motor.

11. The linear actuator of claim 10, wherein the second attachment point is on a plate connected to the housing by the one or more springs, and wherein the limit switch is positioned so as to be engaged by a pin attached to the plate when the one or more springs are compressed.

12. The linear actuator of claim 2, having a plurality of limit switches each configured to detect a different selected compression distance of the one or more springs and trigger the shut off of the motor at one of the selected compression distances.

13. The linear actuator of claim 2, wherein the shaft has a defined travel distance and wherein one or more limit switches are configured to detect when the shaft is approaching at least one end of its travel distance and trigger the shut off of the motor.

14. The linear actuator of claim 2, wherein the motor is configured to produce a signal in response to the compression of the one or more springs and trigger the shut off of the motor.

15. The linear actuator of claim 14, wherein the motor is a servo motor and the signal is an increase in power consumption of the motor when moving the shaft and compressing the one or more springs, relative to the power consumption of the motor when moving the shaft without compressing the one or more springs.

16. The linear actuator of claim 15, wherein the increase in power consumption of the motor varies depending on the compression distance of the one or more springs, and wherein the shut off of the motor may be triggered when the signal corresponds to a desired compression distance.
